(19) United States
(12) Patent Application Publication
(10) Pub. No.: US 2025/0296221 A1
(43) Pub. Date: Sep. 25, 2025

(54) Interlocking Robotic Assembly System

(71) Applicant: New Jersey Institute of Technology, Newark, NJ (US)

(72) Inventor: Petras Swissler, South Orange, NJ (US)

(73) Assignee: New Jersey Institute of Technology, Newark, NJ (US)

(21) Appl. No.: 19/081,161

(22) Filed: Mar. 17, 2025

Related U.S. Application Data
(60) Provisional application No. 63/567,623, filed on Mar. 20, 2024.

(51) Int. Cl. B25J 9/00; B25J 5/00; B25J 19/00

(52) U.S. Cl. CPC B25J 9/0009; B25J 5/007; B25J 19/0075

(57) ABSTRACT

An example robot is provided that includes a base, a top component coupled to the base, and a transportation assembly associated with the top component. The transportation assembly allows for selective movement of the robot relative to any underlying object or surface. The robot includes a pivoting assembly associated with the top component.

### CROSS-REFERENCE TO RELATED APPLICATIONS

This application claims the benefit of a co-pending, commonly assigned U.S. Provisional Patent Application No. 63/567,623, which was filed on Mar. 20, 2024. The entire content of the foregoing provisional application is incorporated herein by reference.

### STATEMENT OF GOVERNMENT SUPPORT

This invention was made with government support under Award No. 2344289 awarded by the National Science Foundation (NSF). The government has certain rights in the invention.

### FIELD OF THE DISCLOSURE

The present disclosure relates to a robotic assembly system and, in particular, to robots capable of interlocking and assembled in an automated manner to create a structure that enables transport of goods, people, or other objects over the structure.

### BACKGROUND

A variety of natural and non-natural disasters can occur around the world. Such disasters include, but are not limited to, flooding, chemical spills, or the like. In addition, these disasters can occur in different environmental conditions that include extreme temperatures and/or terrains. Further, certain events—such as war conditions—may necessitate crossing of rivers or other terrain in areas that do not have appropriate structures for such crossing. In these instances, it can be difficult to provide aid or quickly build structures that can be used to navigate the existing conditions.

### SUMMARY

In accordance with embodiments of the present disclosure, an exemplary interlocking robotic assembly system is provided. The system includes multiple robots (referred to as a “swarm”) capable of interlocking or joining together in a substantially adjacent manner to define planar (or non-planar) structures that would enable the transport of goods, people, and/or other objects over arbitrary terrain or dangerous conditions. As an example, the swarm of robots can be used to create a bridge over flood waters to allow for transport of goods, people, vehicles, or the like, from dangerous areas to safety (see, e.g., FIG. 20). In some embodiments, the interlocking of robots can occur in an automated, self-assembling manner. In some embodiments, the interlocking of robots can be performed in an automated and controlled manner via a remote user interface.

In accordance with embodiments of the present disclosure, an exemplary robot is provided. The robot includes a base, a top component coupled to the base, and a transportation assembly associated with the top component. The transportation assembly allows for selective movement of the robot relative to any underlying object or surface. The robot includes a pivoting assembly associated with the top component.

In some embodiments, the base can include openings formed around its perimeter. In some embodiments, each opening can include a post and some openings include coupling arms. The coupling arms are rotatable relative to the openings and the base. In some embodiments, the robot can include an attachment assembly configured to extend an arm through one of the openings in the base to releasably interlock with an adjacently disposed secondary robot. In some embodiments, the robot can include a bottom component capable of being releasably secured to a bottom surface of the base. In some embodiments, the bottom component can include at least one of a floatation capability for flotation of the robot, or a corrosion/damage resistance, or both.

The top component of the robot can be rotatably coupled to the base. In some embodiments, the transportation assembly can include sets of wheels positioned at least partially within complementary openings formed in the top component. The top component can include two tracks extending across an entire width of the top component. The two tracks extend parallel to each other in an offset manner. In some embodiments, the transportation assembly can include sets of rotating components rotatably coupled to the top component. The transportation assembly can include a pair of rotatable guide rails capable of being positioned in a retracted position and a deployed position. In the deployed position, rollers rotatably coupled to the rotatable guide rails extend above a top surface of the top component.

In some embodiments, the pivoting assembly can include a pivot arm including a pivot bar rotatably coupled to the top component such that the pivot arm is capable of pivoting into a retracted position and an extended position. The top component can include grooves that at least partially receive the pivot arm in the retracted position. The pivot arm can include sections that extend from the pivot bar. At least one of the sections can be aligned with a side wall of the base when the pivot arm is in the extended position.

In some embodiments, the pivoting assembly can include arms rotatably coupled to a bottom surface of a platform capable of being positioned in a retracted position below a plane defined by the top component and an extended position above the plane defined by the top component. In some embodiments, the top component can include a central section with a hollow interior in which the arms are configured to slide or move across ramped structures to move the platform in and out of the hollow interior. In some embodiments, the arms can be extended into a maximum position to rotate and orient the platform vertically in a perpendicular position relative to the top component.

In accordance with embodiments of the present disclosure, an exemplary interlocking robot assembly system is provided. The system includes a first robot and a second robot. Each of the first and second robots includes a base, a top component coupled to the base, a transportation assembly associated with the top component, a pivoting assembly associated with the top component, and an engagement assembly. The transportation assembly allows for selective movement of the respective robot relative to any underlying object or surface. The engagement assembly of the first and second robots is configured to releasably interlock the first robot to the second robot.

The engagement assembly can include openings formed in the base. In some embodiments, each opening includes a post and some openings include coupling arms. The coupling arms of the respective first and second robots are rotatable relative to the openings to engage with posts and releasably interlock the first robot to the second robot. In some embodiments, an arm of an attachment assembly of the first robot can be configured to extend into one of the openings formed in the base of the second robot to releasably interlock with a complementary attachment assembly of the second robot. Each of the first and second robots can include a communication interface that allows for transfer of data and power upon releasable interlocking of the first robot to the second robot.

In some embodiments, the pivoting assembly can include a pivot arm configured to pivot between a retracted position and an extended position. In some embodiments, the pivoting assembly can include arms configured to move or slide along ramped structures to move a platform coupled to the arms between a retracted position and an extended position. The first robot is configured to be positioned in an upside-down orientation relative to the second robot. In some embodiments, the pivot arms of the first and second robots are configured to couple relative to each other with an attachment mechanism. In some embodiments, the platforms of the first and second robots can be coupled relative to each other before flipping. In the coupled position, the arms are configured to be pivoted to flip the first robot about 180° into a right-side-up position adjacent to the second robot. The first robot is configured to be positioned in an upside-down orientation relative to the second robot, and the transportation assembly allows for movement of the first robot along the second robot.

In accordance with embodiments of the present disclosure, an exemplary method for interlocking robots is provided. The method includes positioning a first robot adjacent to a second robot. Each of the first and second robots includes a base, a top component coupled to the base, a transportation assembly associated with the top component, a pivoting assembly associated with the top component, and an engagement assembly. The transportation assembly allows for selective movement of the respective robot relative to any underlying object or surface. The method includes releasably interlocking the first robot to the second robot with the engagement assembly.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the exemplary interlocking robotic assembly system, reference is made to the accompanying figures, wherein:

FIG. 1 is a perspective view of an exemplary interlocking robot of an interlocking robotic assembly system in accordance with embodiments of the present disclosure.

FIG. 2 is a detailed view of a connection interface of an exemplary interlocking robot of FIG. 1.

FIG. 3 is an exploded view of an exemplary interlocking robot of FIG. 1.

FIGS. 4A-E are diagrammatic views of different configurations of exemplary interlocking robots in an assembled position in accordance with embodiments of the present disclosure, including a hexagonal configuration (FIG. 4A), a square configuration (FIG. 4B), a triangular configuration (FIG. 4C), a rectangular configuration (FIG. 4D), and an offset rectangular configuration (FIG. 4E).

FIG. 5 is a diagrammatic side view of an exemplary interlocking robot of FIG. 1.

FIGS. 6A-C are diagrammatic top views of an exemplary interlocking robot of FIG. 1 showing rotation of a top section relative to a base section, including a first position (FIG. 6A), a second position (FIG. 6B), and a third position (FIG. 6C).

FIGS. 7A-B are diagrammatic side views of exemplary interlocking robots of FIG. 1 in an interlocked or engaged configuration (FIG. 7A) and a non-interlocked or disengaged position (FIG. 7B).

FIGS. 8A-B are diagrammatic side views of exemplary interlocking robots of FIG. 1 with arms in an interlocked or engaged position (FIG. 8A) and a non-interlocked or disengaged position (FIG. 8B).

FIGS. 9A-B are diagrammatic side views of an exemplary interlocking robot of FIG. 1 including an arm in a retracted position (FIG. 9A) and in an extended position (FIG. 9B).

FIGS. 10A-B are diagrammatic side views of an exemplary interlocking robot of FIG. 1 including an arm used to move a package (FIG. 10A) and an arm used to position equipment (FIG. 10B).

FIG. 11 is a side view of an exemplary interlocking robot of FIG. 1 including an arm in an extended position.

FIGS. 12A-C are perspective views of exemplary interlocking robots of FIG. 1 in a stacked configuration (FIG. 12A), in a flipping action (FIG. 12B), and in a flipped and aligned configuration (FIG. 12C).

FIG. 13 is a diagrammatic flow chart illustrating steps for interlocking of exemplary interlocking robots of FIG. 1.

FIG. 14 is a perspective view of an exemplary interlocking robot of FIG. 1 moving across a platform created by other interlocked robots.

FIGS. 15A-C are diagrammatic side views of an exemplary interlocking robot of FIG. 1 moving across a platform created by other interlocked robots, including movement across a first robot (FIG. 15A), across both robots (FIG. 15B), and across a second robot (FIG. 15C).

FIG. 16 is a diagrammatic top view of exemplary interlocking robots of FIG. 1 with misaligned transportation mechanisms.

FIG. 17 is a side view of exemplary interlocking robots of FIG. 1 with misaligned transportation mechanisms.

FIG. 18 is a diagrammatic side view of an exemplary interlocking robot of FIG. 1 moving across a platform created by other interlocked robots.

FIGS. 19A-C are diagrammatic side views of exemplary interlocking robots of FIG. 1 during a flipping action, including a stacked position (FIG. 19A), a partially flipped position (FIG. 19B), and a fully flipped position (FIG. 19C).

FIG. 20 is a diagrammatic view of exemplary interlocking robots of FIG. 1 interlocked to form a floating platform across flood waters.

FIG. 21 is a perspective view of an exemplary interlocking robot of an interlocking robotic assembly system in accordance with embodiments of the present disclosure, including a transport assembly in the form of rollers and roller tracks shown in a retracted position.

FIG. 22 is a perspective view of an exemplary interlocking robot of FIG. 21, including rollers and roller tracks of a transport assembly in a deployed position.

FIG. 23 is a perspective, exploded view of an exemplary interlocking robot of FIG. 21.

FIG. 24 is a perspective, partial view of an attachment assembly of exemplary interlocking robots of FIG. 21 that facilitates releasable engagement between adjacently disposed robots.

FIG. 25 is a cross-sectional view of an attachment assembly of FIG. 24 illustrating a spaced position of an arm extending from a first interlocking robot towards a complementary interface of a second interlocking robot for engagement.

FIG. 26 is a cross-sectional view of an attachment assembly of FIG. 24 illustrating a partially engaged arm of a first interlocking robot with a complementary interface of a second interlocking robot.

FIG. 27 is a cross-sectional view of an attachment assembly of FIG. 24 illustrating a fully engaged arm of a first interlocking robot with a complementary interface of a second interlocking robot.

FIG. 28 is a diagrammatic view of non-latticed or non-hexagonal interlocking robots in an assembled position relative to each other.

FIG. 29 is a diagrammatic view of latticed/hexagonal and non-latticed/hexagonal interlocking robots in an assembled position relative to each other.

FIG. 30 is a perspective view of exemplary interlocking robots of FIG. 21 in a flipping action.

FIG. 31 is a side view of an exemplary interlocking robot of FIG. 21 including an arm assembly in a retracted position.

FIG. 32 is a side view of an exemplary interlocking robot of FIG. 21 including an arm assembly in a partially extended position.

FIG. 33 is a side view of an exemplary interlocking robot of FIG. 21 including an arm assembly in an extended position.

FIG. 34 is a diagrammatic view of exemplary interlocking robots of FIG. 21 interlocked to form a floating platform across muddy waters.

### DETAILED DESCRIPTION

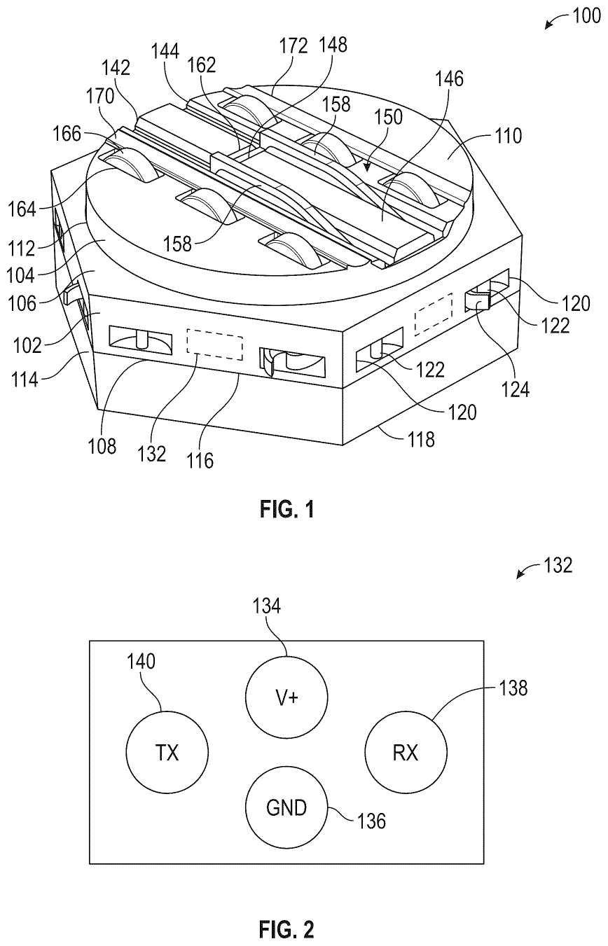

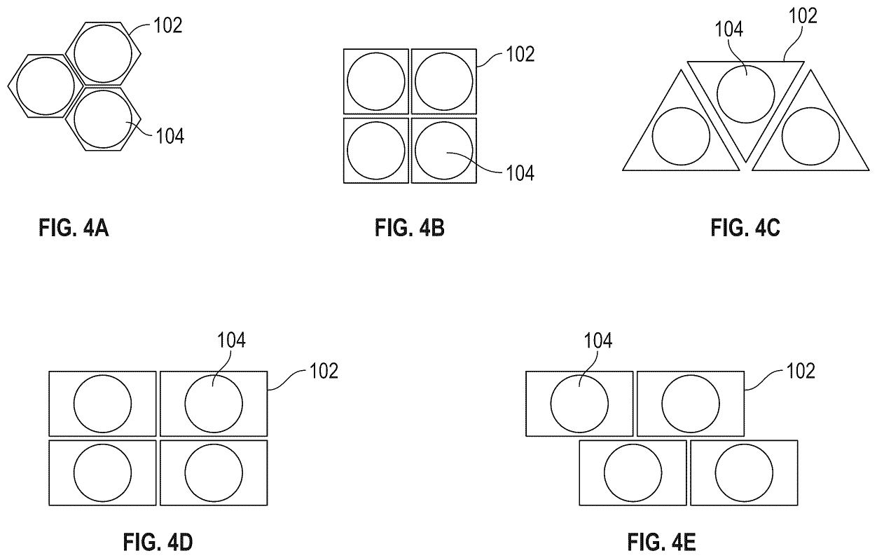

FIGS. 1-3 are perspective, detailed, and exploded views of an exemplary interlocking robot 100 (hereinafter “robot 100”). The robot 100 generally includes a base 102 and a top component 104 movably and/or rotatably connected to the base 102. In some embodiments, the base 102 can define side walls with a hexagonal configuration, and includes substantially flat and parallel top and bottom opposing surfaces 106, 108. In some embodiments, the base 102 can define any configuration for the side walls, e.g., hexagonal, square, triangular, rectangular, or the like (see, e.g., FIGS. 4A-E). In some embodiments, the overall diameter of the base 102 can be about, e.g., 6-36 inches inclusive, 10-36 inches inclusive, 15-36 inches inclusive, 20-36 inches inclusive, 25-36 inches inclusive, 30-36 inches inclusive, 6-30 inches inclusive, 6-25 inches inclusive, 6-20 inches inclusive, 6-15 inches inclusive, 6-10 inches inclusive, 10-30 inches inclusive, 15-25 inches inclusive, 6-24 inches inclusive, 12-24 inches inclusive, 12-36 inches inclusive, 24-36 inches inclusive, 6 inches, 10 inches, 12 inches, 15 inches, 20 inches, 24 inches, 25 inches, 30 inches, 36 inches, or the like. In some embodiments, the overall diameter of the base 102 can be about, e.g., 6-78 inches inclusive, or the like. In particular, the base 102 can be dimensioned a variety of sizes depending on the environment and intended use of the robot 100. The top component 104 can define a cylindrical configuration with substantially flat and parallel top and bottom opposing surfaces 110, 112. The bottom surface 112 of the top component 104 is positioned immediately adjacent and over the top surface 106 of the base 102 such that the longitudinal axis of the base 102 and the top component 104 are aligned.

In some embodiments, the robot 100 can include an optional bottom component 114 that can be selectively coupled to the base 102. The bottom component 114 can include side walls with a configuration complementary to the configuration of the side walls of the base 102, such that the side walls of the base 102 and the bottom component 114 align. The bottom component 114 includes a top surface 116 and an opposing bottom surface 118 that are both substantially flat and parallel, with the top surface 116 positioned immediately adjacent to the bottom surface 108 of the base 102. The thickness of the bottom component 114 as measured between the top and bottom surfaces 116, 118 can be any dimension, and can be selected depending on the intended application. For example, for a floating application, if the interlocked structure of the robots 100 is intended to support heavier weight, a larger thickness for the bottom component 114 can be selected to provide greater floatation support.

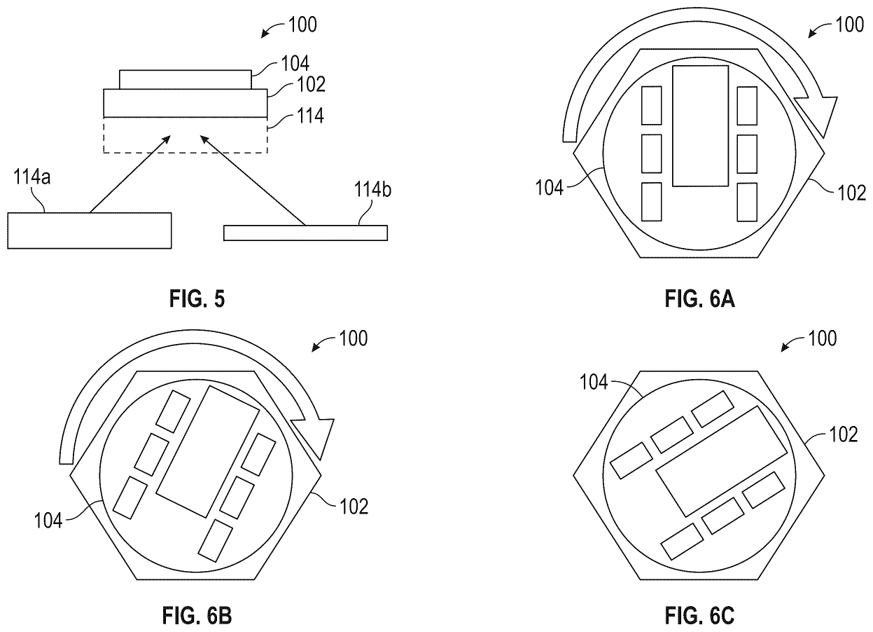

The bottom component 114 can be removable or detachable from the base 102, and can be interchanged depending on the intended use of the robot 100 (e.g., the intended environment in which the robot 100 is to be used) (see, e.g., FIG. 5). For example, the bottom component 114 can provide improved floatation for water/flooding environments, puncture resistance, chemical resistance, heat resistant, armored to provide resistance to various abrasive environments, a specific surface that can be on grass or turf without damaging the grass, operation on rubble without damage to the robot 100, operating in corrosive or other damaging environments without damage to the robot 100, or a combination of such capabilities. Before use, the bottom component 114 desired for the particular application can be selected and coupled to the base 102 of the robot 100 before use. In some embodiments, the robot 100 can be used without the bottom component 114.

Still with reference to FIGS. 1-3, the base 102 includes multiple openings 120 formed in the side walls of the base 102. In some embodiments, each section of the hexagonal structure of the base 102 can include two openings 120. The openings 120 at least partially contain features for selectively attaching or coupling adjacently positioned robots 100 to each other. Each opening 120 defines a hollow interior space formed in the body of the base 102. Each opening 120 can include a vertical post 122 fixedly positioned within the hollow interior space adjacent to the edge of the opening 120. The post 122 spans the entire height of the opening 120, and extends from the top to the bottom interior surface of the opening 120.

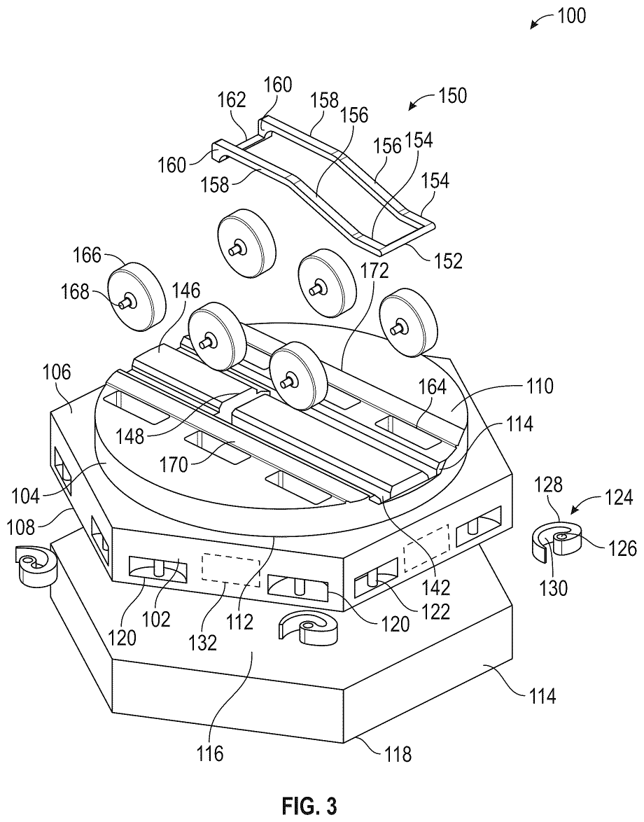

One of the openings 120 includes a coupling arm 124 rotatably attached to the post 122. The coupling arm 124 includes an opening 126 formed in the body that is configured to receive the post 122 therethrough such that the coupling arm 124 rotates about the post 122 (see, e.g., FIG. 3). From this central area of the body, the coupling arm 124 includes a curving extension 128 that defines at least a 180° curvature relative to the opening 126 with a hollow passage 130 formed between the extension 128 and the central section of the body of the coupling arm 124. The coupling arm 124 (or post 122 associated with the coupling arm 124) can be connected to an actuator that allows for selective rotation of the coupling arm 124 in and at least partially out of the opening 120.

In operation, when two robots 100 are positioned adjacent to each other, the openings 120 of the robots 100 align. Once aligned, the coupling arms 124 can be rotated out of the openings 120, which engages and interlocks the robots 100 together. In particular, during rotation of the coupling arm 124, the hollow passage 130 of the coupling arm 124 receives the post 122 of the adjacently positioned robot 100, and vice versa. The coupling arm 124 of the first robot 100 therefore engages and interlocks with the post 122 of the second robot 100, and the coupling arm 124 of the second robot 100 engages and interlocks with the post 122 of the first robot 100. Thus, two points of coupling occur between the robots 100.

In some embodiments, the robot 100 can include a communication and/or power sharing/transfer section 132. The section 132 can be located on each of the hexagonal sides of the robot 100, such that positioning of adjacent robots 100 together allows for data communication and/or power sharing/transfer to occur between the robots 100. The sections 132 can include electrical connectors that enable the robots 100, when contacting, to share power and/or data. In some embodiments, other methods of communication can be incorporated into the robots 100 (e.g., Bluetooth, WiFi, combinations thereof, or the like). In some embodiments, the section 132 can include individual contacts for voltage 134, ground 136, receiving 138, and transmitting 140 (see, e.g., FIG. 2). The arrangement of the voltage 134 and ground 136 connections vertically ensures that when two robots 100 are positioned against each other, their respective voltage 134 and ground 136 connections will align and engage. The arrangement of the receiving 138 and transmitting 140 connections horizontally ensures that when two robots 100 are positioned against each other, one robot's 100 receiving 138 connection will align and engage with the other robot's 100 transmitting 140 connection, and vice versa. Communication between multiple robots 100 arranged and interlocked together can therefore be achieved.

The highest points of the top surface 110 of the top component 104 extends along the same plane. The top surface 110 includes a pair of grooves 142, 144 extending parallel in a spaced manner across the entire top surface 110 to cross the top component 104. The grooves 142,144 form between them a raised platform 146 that also spans the entire top surface 110 and defines a substantially central area of the top component 104. The top component 104 includes a lateral groove 148 that crosses the raised platform 146 and connects the grooves 142, 144 in a perpendicular orientation. The lateral groove 148 is offset from the center of the raised platform 146. The grooves 142, 144, 148 are configured and dimensioned to at least partially receive therein an arm 150 of the robot 100.

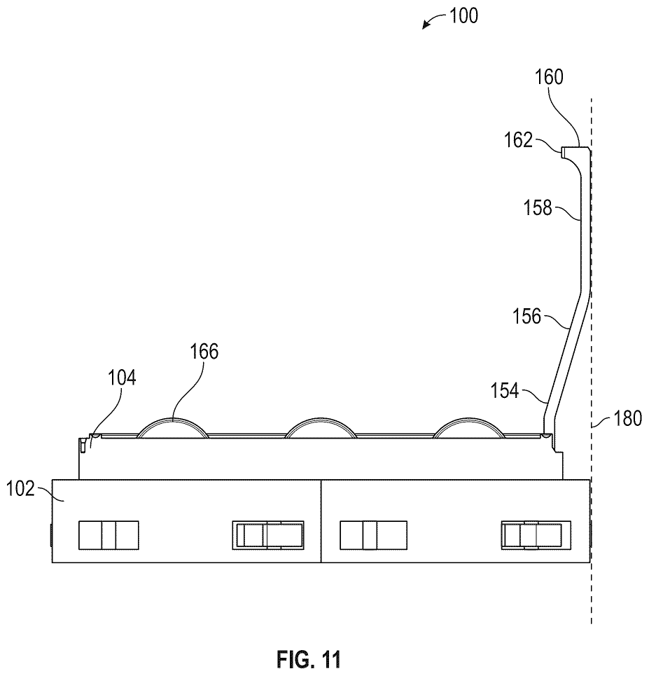

The arm 150 forms a pivoting assembly of the robot 100 and generally includes a pivot bar 152 at a proximal end, and a pair of extensions extending from opposing ends of the pivot bar 152. The pivot bar 152 is movably coupled to the top component 104 under the raised platform 146 such that the arm 150 can pivot from a retracted position (see, e.g., FIG. 1) to an extended position (see, e.g., FIG. 11). Each pair of extensions includes a first section 154 extending from the ends of the pivot bar 152, a second section 156 extending from the opposing end of the first section 154 at an upward angle relative to the first section 154, and a third section 158 extending from the opposing end of the second section 156 along a plane parallel with the first section 154. The distal end of the third section 158 includes downward directed hooks 160, and a distal bar 162 spans between and connects the opposing hooks 160. Thus, the arm 150 defines a substantially rectangular configuration. In the retracted position, as illustrated in FIG. 1, the distal bar 162 fits at least partially within the lateral groove 148, and the first sections 154 at least partially fit within the grooves 142, 144. In some embodiments, in the retracted position, the entire arm 150 can fit within respective grooves 142, 144, 148 such that the arm 150 does not extend beyond the plane of the top surface 110.

The top surface 110 of the top component 104 includes two groups of openings 164 formed in the top surface 110 on opposing sides of the grooves 142, 144. For example, each group can include three openings 164 aligned with each other in a direction parallel to the grooves 142, 144. The openings 164 are configured and dimensioned to receive at least partially therein a transportation assembly, e.g., wheels 166. In some embodiments, belt drives and/or walking beams can be used as the transportation assembly. Each wheel 166 includes an axle 168 that allows the wheel 166 to be rotatably installed within the opening 164. The wheels 166 allow the robot 100 to move over various terrain and over other robots 100, as discussed herein. The robot 100 can include one or more motors or actuators within its body/housing to selectively operate rotation of the wheels 166.

In some embodiments, the top surface 110 of the top component 104 can include a pair of tracks 170, 172 (e.g., grooves, or the like) formed in the top surface 110. The tracks 170, 172 can define concave areas in the top surface 110 that extend parallel to the openings 164. The depth of the tracks 170 172 is dimensioned smaller than the depth of the grooves 142, 144. The tracks 170, 172 can provide a surface along which the wheels 166 of another robot 100 can travel as one robot 100 travels over another robot 100. In some embodiments, one track 170 can be formed between the openings 164 and the groove 142, and another track 172 can be formed adjacent to the openings 170 away from the groove 144. The robot 100 therefore includes features for transporting the robot 100 between desired locations, features for interlocking with other robots 100, and features for engaging with robots 100 traveling over them for flipping and repositioning before interlocking occurs. Details of such operations are discussed below.

FIGS. 4A-E show different configurations of the base 102 of the robot 100. Any configuration of the base 102 can be used to accommodate adjacent positioning and interlocking of the robots 100. In particular, the configuration/shape of the base 102 is selected for tessellating, enabling many robots to form a surface or platform together when interlocked. The configuration/shape of the base 102 and the interlocking engagement of the posts 122 and coupling arms 124 allows for slight misalignment between components, thereby enabling the assembly to conform non-planar underlying surfaces as well. As non-limiting examples, the base 102 can be, e.g., hexagonal (FIG. 4A), square (FIG. 4B), triangular (FIG. 4C), rectangular/quadrilateral (FIG. 4D), and offset or shifted rectangular/quadrilateral (FIG. 4E).

FIG. 5 is a diagrammatic view of the robot 100 showing the interchangeable base component 114. In particular, the robot 100 can be customized for the intended use/environment by selecting and installing the desired base component 114 onto the bottom of the base 102. As an example, a selection can be made between a base component 114a, 114b having different thicknesses or different performance specifications.

FIGS. 6A-C illustrate the rotatable engagement of the top component 104 relative to the base 102. The top component 104 rotate as shown over the base 102 by a full 360°. Rotation of the top component 104 is automated via a motor within the robot 100. In some embodiments, the robot 100 can include one or more sensors to guide the rotation of the top component 104, e.g., based on alignment with other top components 104 of adjacent robots 100. In some embodiments, the robot 100 can include sensors for, e.g., enabling the robot 100 to sense its own internal state, such as limit switches for arm 150 position, encoders for motor for swiveling of the top component 104; world or environment sensors for determining the current state of the environment, combinations thereof, or the like. The top component 104 position can therefore be customized based on the intended operation of the robot 100.

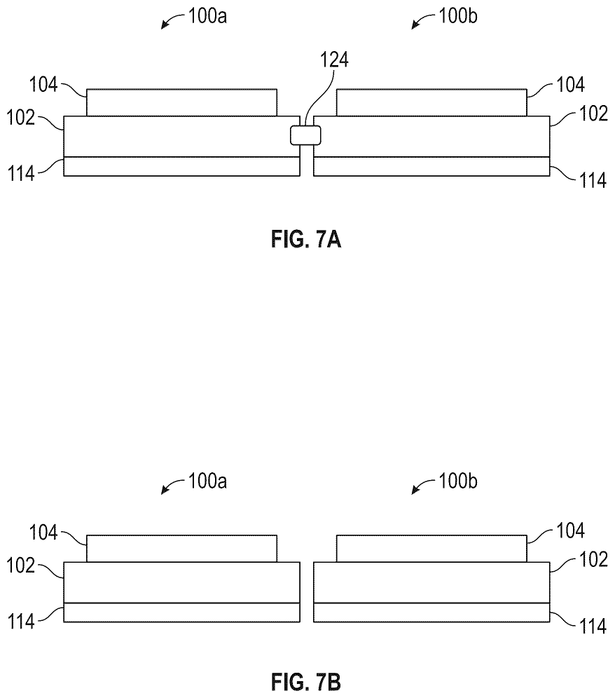

FIGS. 7A-B show adjacently positioned robots 100a, 100b in interlocked/engaged and non-interlocked/disengaged positions. In some embodiments, the robots 100a, 100b can be programmed to self-assembly and interlock with each other (and other robots) to build a platform or other surface for transport of people or vehicles across the platform. The robots 100a, 100b initially position adjacent to each other such that the openings 120 in the top component 104 align with each other. Next, the attachment mechanism (e.g., the coupling arms 124) rotate to wrap around and secure around the post 122 of the opposing robot 100a, 100b. Two such engagements occur between each pair of robots 100a, 100b to ensure a strong connection occurs. Although coupling arms 124 are shown, in some embodiments, the attachment mechanism can be, e.g., latches, grabbers, screw-style attachments, jamming mechanisms, electromagnets, continuous docking systems, soldering connections, combinations thereof, or the like. When disengagement is needed, the attachment mechanism rotates to disengage from the complementary component in the adjacent robot 100a, 100b (e.g., the coupling arm 124 disengages from the post 122) to allow for separation of the robots 100a, 100b.

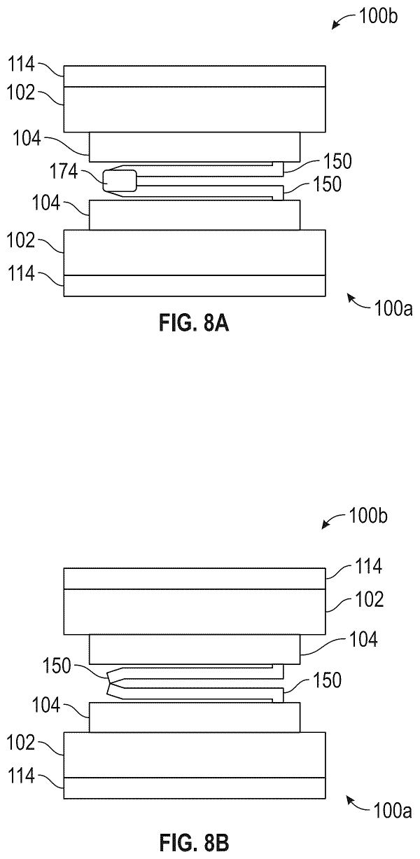

With reference to FIGS. 8A-B, the robots 100a, 100b can be used to transport and position other robots 100a, 100b adjacent to each other for interlocking. One robot 100a can be positioned in a normal orientation, and a second robot 100b can be positioned upside-down on the robot 100a. The wheels 166 of the robot 100b (alone or in combination with the wheels 166 of the robot 100a) transport the robot 100b over the robot 100a until the arms 150 are aligned. Upon alignment, an attachment mechanism 174 can be actuated to engage the distal bar 162 of the arms 150 of the respective robots 100a, 100b to each other. The attachment mechanism 174 can be, e.g., hooks, latches, grabbers, screw-style attachments, jamming mechanisms, electromagnets, continuous docking systems, soldering connectors, other mechanism mechanisms, combinations thereof, or the like. Such engagement of the arms 150 to each other allows the robots 100a, 100b to operate in combination to reposition and/or flip the robot 100b into position for top component 104 engagement. FIG. 8A shows the robots 100a, 100b engaged with each other using the attachment mechanisms 174, and FIG. 8B shows the robots 100a, 100b disengaged from each other.

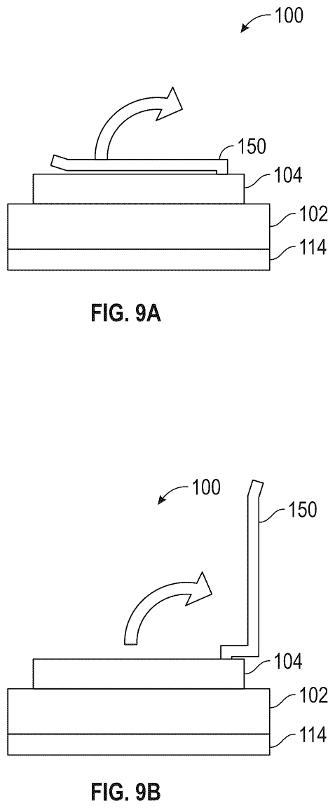

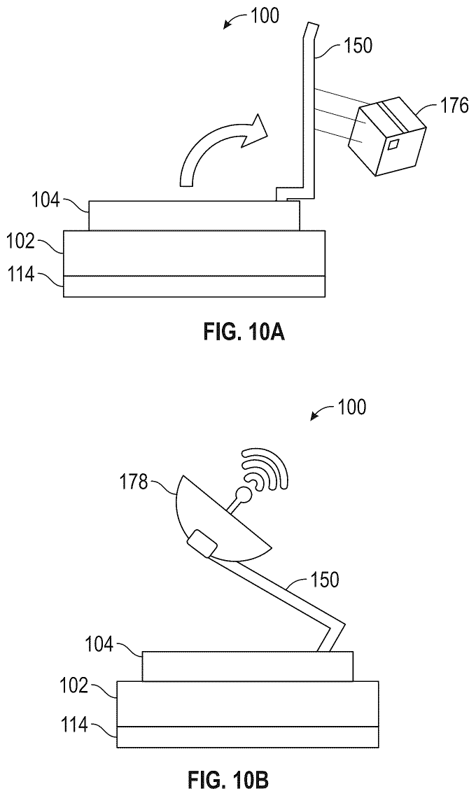

FIGS. 9A-B illustrate the capability of the arm 150 to pivot/rotate relative to the top component 104. The proximal end of the arm 150 is rotatably coupled to the top component 104 such that the arm 150 can be flipped or rotated into an extended position, as shown in FIG. 9B. In the extended position, the arm 150 is oriented substantially perpendicularly relative to the top component 104. The arm 150 can be selectively pivoted into the retracted position, as shown in FIG. 9A. Extension of the arm 150 can be used for, e.g., flipping of other robots 100 positioned on top of the base robot 100, movement of objects, positioning of equipment, or the like. For example, FIG. 10A shows the arm 150 being extended to move or dump a package 176, and FIG. 10B shows the arm 150 being extended partially to position equipment 178 (e.g., a satellite dish attached or grabbed on to by the arm 150, or the like). The arm 150 geometry is such that when the fully extended position is reached, the section 158 of the arm 150 is aligned with and extends parallel to the side of the base 102 (as shown by plane 180 in FIG. 11).

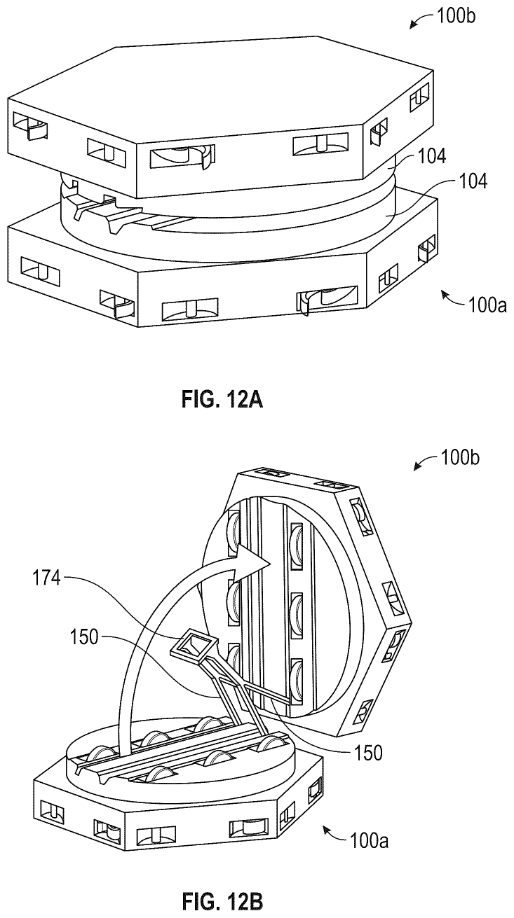

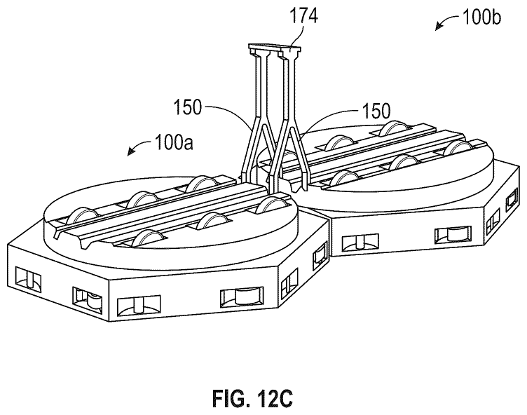

With reference to FIGS. 12A-C, the robots 100a, 100b can be used to flip robots 100a, 100b into position for interlocking engagement with each other. The robots 100a, 100b initially position themselves such that the top components 104 align, thereby aligning the arms 150. The distal end of the arms 150 couple together with an attachment mechanism 174. The arms 150 subsequently pivot simultaneously in a controlled manner to flip the top robot 100b into an adjacent position, as shown in FIG. 12C. The flipped position can be such that the side walls of the base 102 are positioned immediately adjacent to each other and ready for interlocking. Next, the attachment mechanism 174 can disengage and the arms 150 can be pivoted back into their retracted position before (or simultaneous to) to interlocking of the robots 100a, 100b.

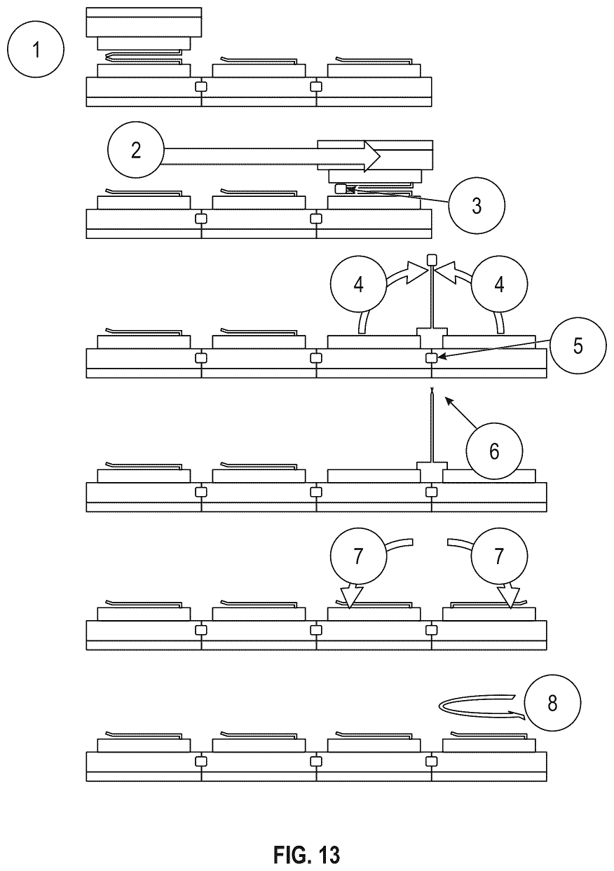

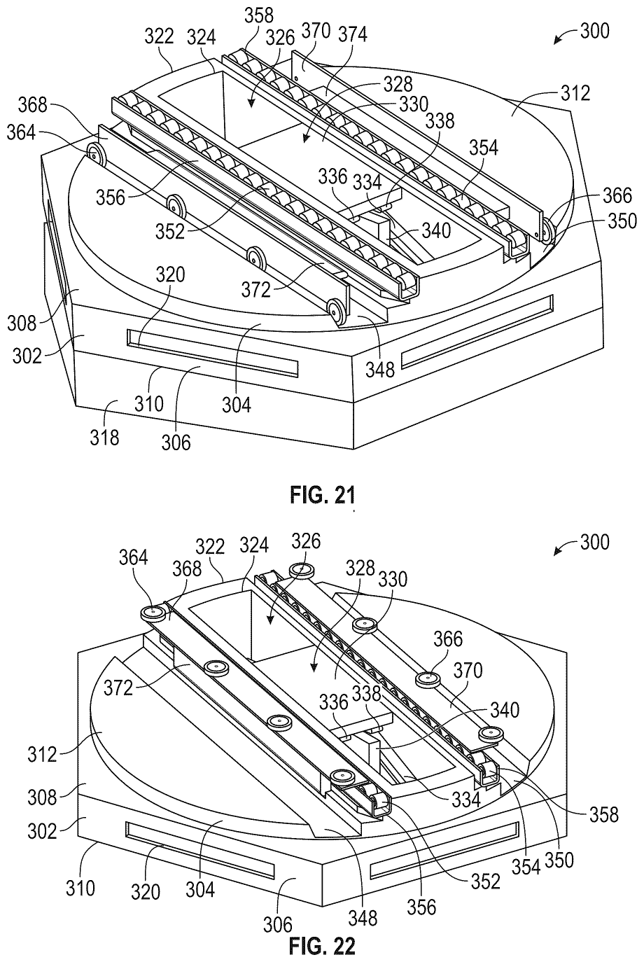

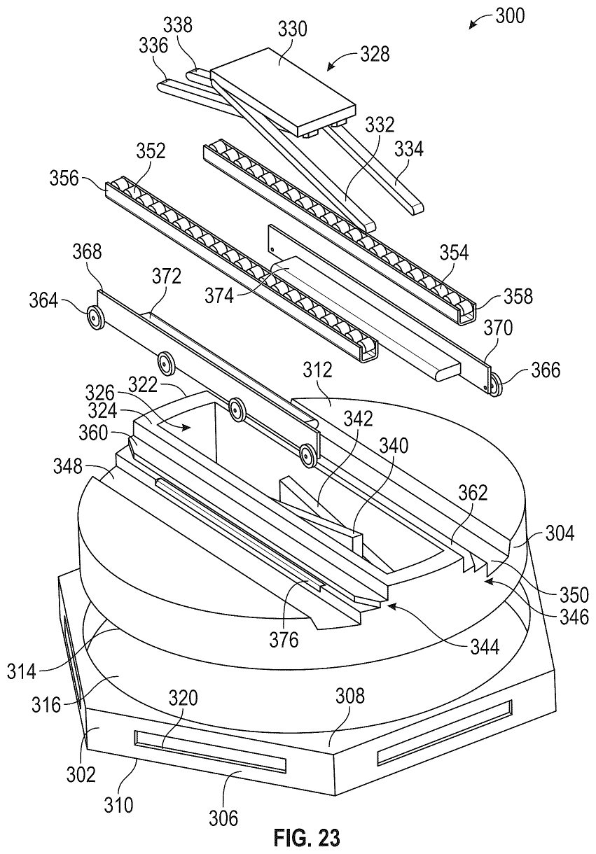

FIG. 13 is a diagrammatic flow chart of the flipping and interlocking steps for the exemplary robots. At step 1, the top robot is placed inverted on a platform formed by previously interlocked robots. The self-assembly algorithm directs the top robot to the endmost point in preparation for flipping. At step 2, the top robot moves to the end-most underlying robot such that the arms of the top component align. At step 3, the arms are attached/coupled together by an attachment mechanism. At step 4, the arms pivot to flip the top robot into an adjacent/aligned position. At step 5, the coupling arms of the adjacent robots engage with each other to interlock the robots. At step 6, the attachment mechanism disengages the arms. At step 7, the arms pivot into the retracted position. At step 8, the top component of the last robot is rotated/swiveled into an aligned position to the other robots (e.g., into a direction of travel) to prepare for a subsequent robot to travel into flipping position. In some embodiments, the arms associated with the platform can be symmetric, resulting in an aligned position without having to rotate/swivel the robot (see, e.g., robot 300 of FIGS. 21-23). As a result, step 8 may not be needed for the symmetric configuration of the platform/arm design.

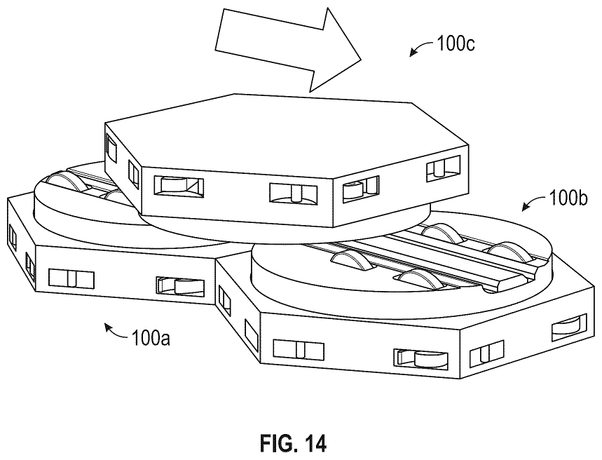

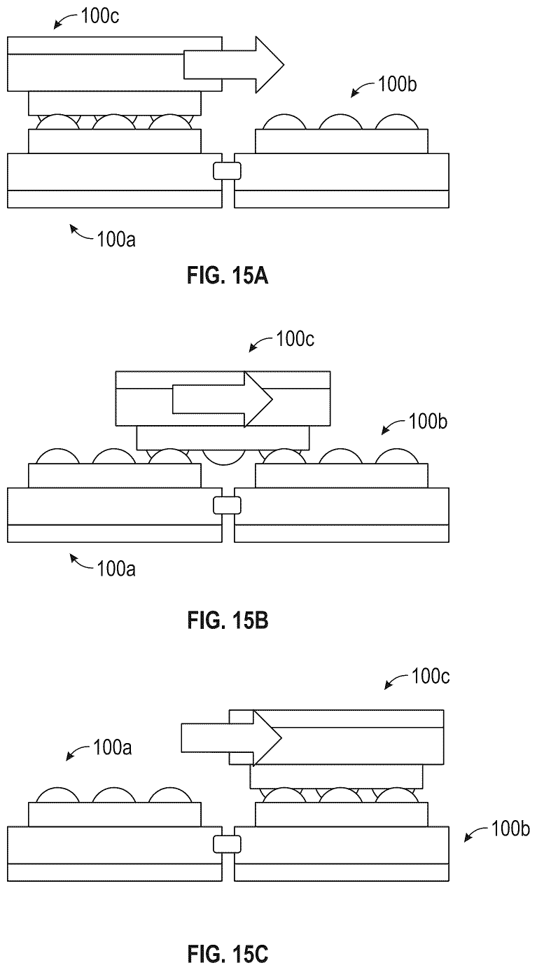

FIG. 14 is a detailed view of steps 1 and 2 of FIG. 13, with robots 100a, 100b forming the interlocked platform/structure that accommodates travel of the top upside-down robot 100c. FIGS. 15A-C similarly show steps 1 and 2 of FIG. 13, with the robot 100c initially started over robot 100a and traveling across the interlocked assembly to a position over robot 100b in preparation for flipping. In some embodiments, the robot 100c can be used to move objects positioned on the robot 100c across the interlocked platform/structure. The robots 100c can therefore be used to transport other robots or objects on top of themselves.

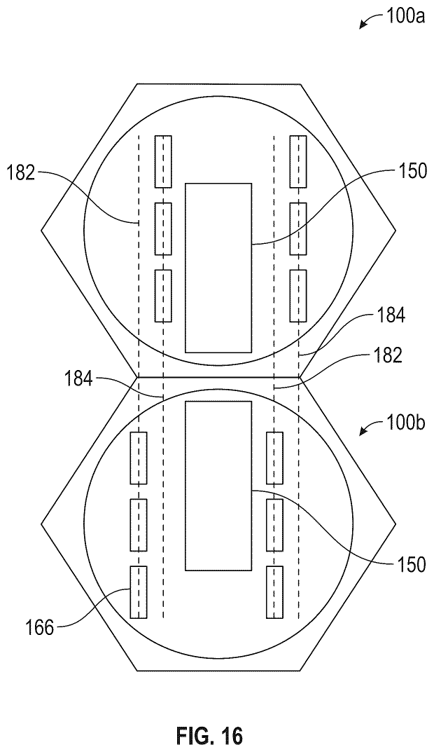

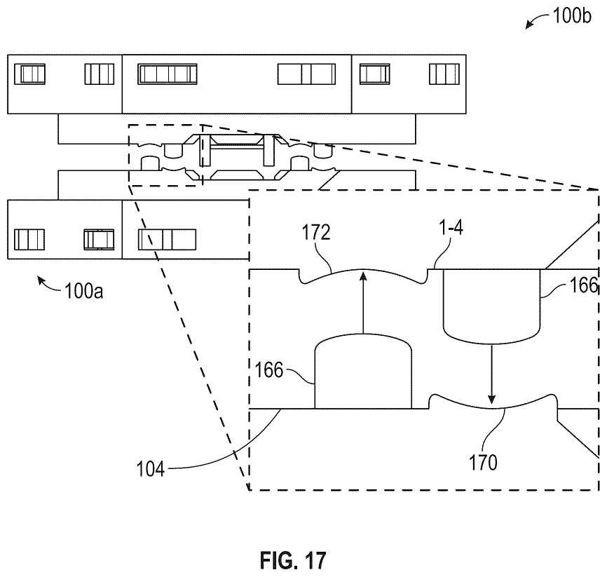

In some embodiments, as illustrated in FIGS. 16 and 17, the wheels 166 (or other transportation means) of the robots 100a, 100b can be misaligned by a distance measured between wheel planes 182, 184. In such misaligned configuration, when the robots 100a, 100b are stacked over each other, the wheels 166 are not positioned over each other. Tracks 170, 172 formed in the top component 104 are used to receive and guide travel of the wheels 166. Tracks 170, 172 therefore assist in maintaining alignment of the robots 100a, 100b as they travel relative to each other.

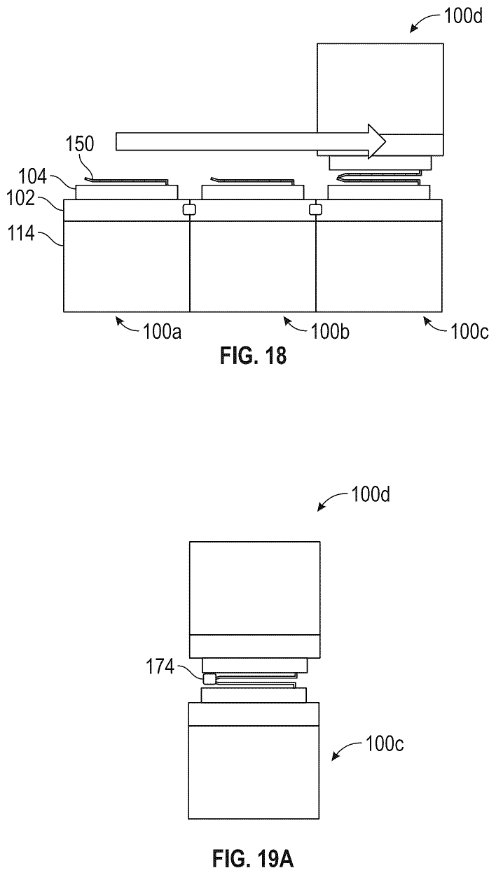

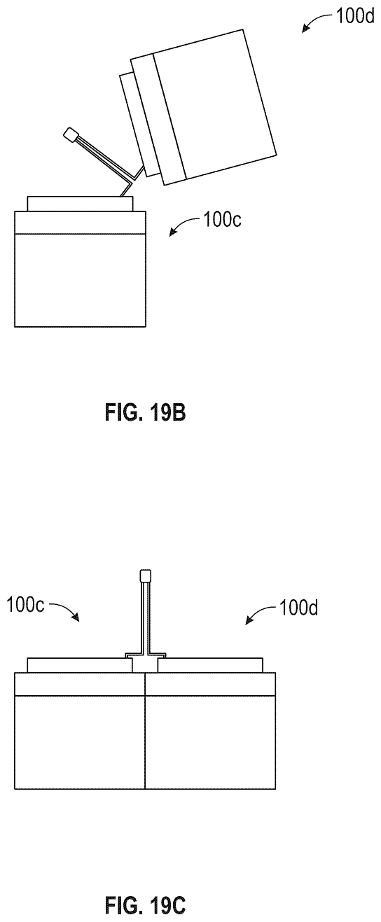

FIG. 18 shows transport of a top inverted or upside-down robot 100d over an interlocked structure formed by robots 100a, 100b, 100c. As noted previously, the optional bottom component 114 can be customized and interchangeable depending on the intended use of the assembly or system of robots. Because robots are transported in an inverted orientation, the thickness of the bottom component 114 does not affect the storage and operation of the robot. FIGS. 19A-C show flipping of the top robot 100d using the interlocked arms such that the robots 100c, 100d are positioned immediately adjacent to each other for interlocking.

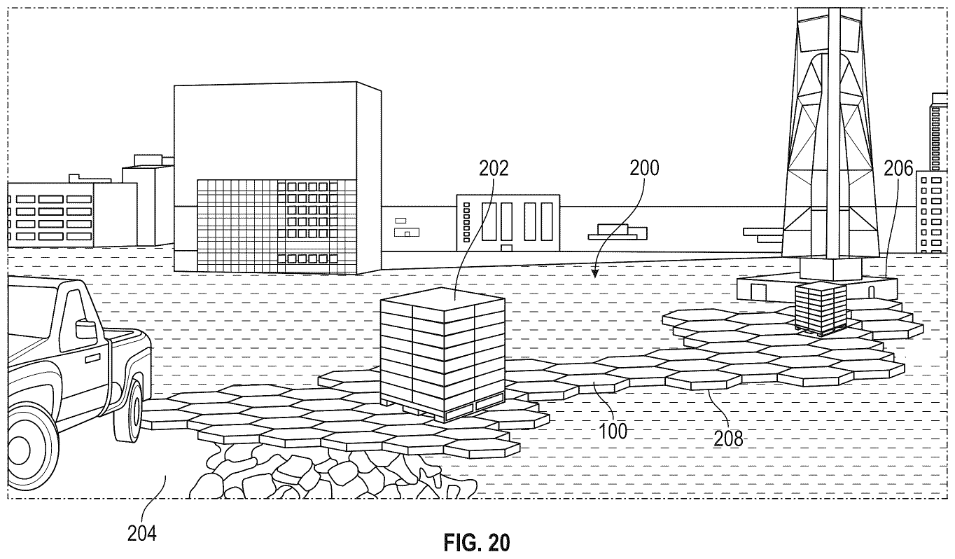

FIG. 20 shows an example environment in which the robots 100 can be used. In particular, FIG. 20 shows a flooded area 200 over which packages 202 need to be transported from one side 204 to another side 206. Robots 100 can be selected to have a bottom component that promotes flotation. Robots 100 can be used to form a structure or platform 208 of interlocked robots 100 that allow the packages 202 to be transported over the flooded area 200. In some embodiments, the robots 100 can be programmed to positioned and self-assemble themselves in the desired direction to form the platform 208. In some embodiments, the platform 208 can be assembled with assistance from users. The system or assembly of robots 100 therefore allows for selective creation of structures capable of being used in various environments and for different purposes.

FIGS. 21-23 are perspective and exploded views of an exemplary interlocking robot 300 (hereinafter “robot 300”). The robot 300 can be substantially similar in structure and function to the robot 100 of FIGS. 1-3, except for the distinctions noted herein. The robot 300 includes a base 302 with a top component 304 movably and/or rotatably connected to the base 302. The base 302 can define substantially flat/planar and parallel opposing top and bottom surfaces 308, 310. Although illustrated as having a hexagonal configuration with substantially uniform side surfaces 306, it should be understood that the base 302 can define any configuration, e.g., hexagonal, square, rectangular, oval, circular, or the like. Any configuration of the base 302 of the robot 300 allows for releasable engagement and interlocking between the robots 300. Thus, similarly shaped robots 300 can engage with each other, and with robots 300 having different configurations, using the engagement mechanisms discussed herein.

The top component 304 can define a substantially cylindrical configuration, as shown in FIGS. 21-23, although other configurations are also envisioned. The top component 304 can include substantially flat/planar and parallel opposing top and bottom surfaces 312, 314. In some embodiments, the top component 304 can be movably mounted to the top surface 308 of the base 302. In some embodiments, the base 302 can include a recessed area 316 formed in the top surface 308 and complementary to the configuration of the top component 304, such that the bottom surface 314 can be at least partially inserted into the recessed area 316. In this configuration, the side walls of the recessed area 316 can assist in guiding the rotation of the top component 304 relative to the base 302.

In some embodiments, the robot 300 can include an optional bottom component 318 that can be selectively coupled to the base 302. The bottom component 318 can include a configuration complementary to the configuration of the base 302, with substantially planar/flat opposing top and bottom surfaces. The thickness or size of the bottom component 318 can be selected based on the intended application of the robot 300. For example, for a floating application, the thickness of the bottom component 318 can be greater if a large weight is to be supported by the interlocked robots 300, thereby providing greater floatation support. The bottom component 318 can be removable or detachable from the base 302 and can be interchanged depending on the intended use of the robot 300 (e.g., similar to the bottom component 114).

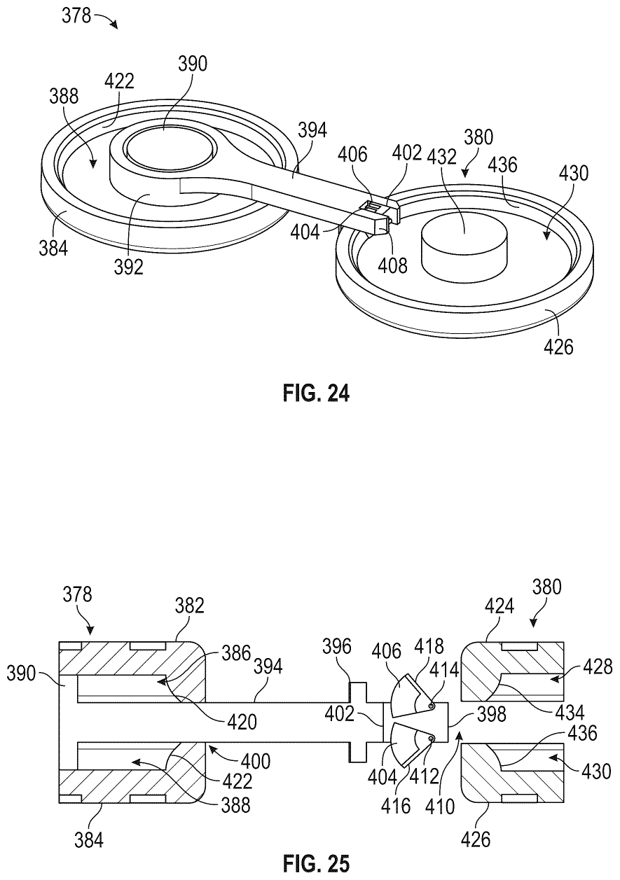

Each of the sides surfaces 306 of the base 302 can include slots or openings 320 formed therein and extending into the interior of the base 302. The openings 320 can be elongated and are sufficiently dimensioned to permit passage of an attachment assembly that allows the robots 300 to interlock with other robots 300 (see FIGS. 24-27). The attachment assembly of a first robot 300 can extend from the opening 320 to engage with the attachment assembly of the adjacently positioned second robot 300 and, once engaged, the attachment assemblies can pull the robots 300 together into an abutting relationship to ensure a sufficiently strong interlocking structure. In some embodiments, the robot 300 can include a communication and/or power sharing/transfer section 132 (see FIGS. 1-3).

The top surface 312 of the top component 304 generally extends along the same plane, and is separated by a transport and platform assembly disposed at a central portion of the top surface 312. In particular, the top component 304 can include a raised central section 322 with an opening 324 leading to a hollow interior 326 of the top component 304. The hollow interior 326 receives a platform assembly 328 (e.g., a pivoting assembly) capable of being selectively retracted or extended out of the hollow interior 326. The platform assembly 328 can be operated to, e.g., raise items above the top plane or surface of the top component 304, flip items off of the top component 304 and onto other robots 300 or surfaces (for example), releasably couple with other robots 300 for flipping onto the other robot 300 or flipping the other robot 300 onto itself, or the like.

The platform assembly 328 generally includes a platform 330 with a substantially rectangular configuration and having a substantially flat top surface capable of supporting items or other robots 300. The bottom surface of the platform 330 can be coupled to multiple struts or arms 332, 334, 336, 338. Each arm 332-338 can be in the form of linear or pivotally coupled linkages capable of being actuated to move the platform 330 into the desired orientation. In some embodiments, the distal ends of the arms 332-338 can move along a flat or horizontal bottom surface of the hollow interior 326 to reposition the platform 330.

In some embodiments, the hollow interior 326 can include oppositely oriented, upwardly ramped structures 340, 342 (e.g., guides), and the distal ends of the arms 332-338 can be actuated to move along the ramped structures 340, 342 to extend or lower the platform 330 relative to the top component 304. The platform assembly 328 allows the platform 330 to be selectively moved with three degrees of freedom, e.g., x, y and rotation. The arms 332-338 can be actuated back and forth, the top component 304 can be rotated relative to the base 302, and the angle of the platform 330 relative to the arms 332-338 can be selectively varied. In particular, the arms 332-338 can be moved along the ramped structures 340, 342 via, e.g., linear actuators, lead screws, pulley screws, a pulley system, combinations thereof, or the like, mounted either to the base of the hollow interior 326 and/or to the ramped structures 340, 342. The angle of the platform 330 can be controlled by, e.g., a linear actuator, a pulley system, or the like, coupling the platform 330 to the arms 332-338, and/or to the base of the hollow interior 326.

Immediately on opposing sides of the raised central section 322, the top component 304 can include downwardly directed stepped structures 344, 346 which end in a groove 348, 350 extending from edge to edge along the top surface 312. The stepped structures 344, 346 and the grooves 348, 350 extend parallel to each other. The robot 300 can include a drive system formed by two sets of rotating components 352, 354 (e.g., rollers, wheels, conveyor belts, chain, combinations thereof, or the like). As shown in FIGS. 21-23, the rotating components 352, 354 can be include multiple rotating components 352, 354 aligned in parallel rows or arrays.

In some embodiments, each of the rotating components 352, 254 can include a rotation axle coupled on opposing sides to side walls of a substantially U-shaped frame 356, 358 (e.g., roller tracks). The bottom surface of the U-shaped frame 356, 358 can be fixed to a step 360, 362 of the stepped structures 344, 346 such that the uppermost surface of the rotating components 352, 254 extends beyond the uppermost surface of the central section 322. This extension of the rotating components 352, 354 allows for items to slide over the rotating components 352, 354 without interference with other structures of the robot 300.

The robot 300 can include a movable transport system including sets of rollers 364, 366 disposed in a parallel on opposing sides of the central section 322. The rollers 364, 366 can be mounted in a spaced manner along a substantially planar guide rail 368, 370 that extends the length of the respective groove 348, 350. Although illustrated as including four roller 364, 366 on each side, the robot 300 can include more or less rollers 364, 366. A support flange 372, 376 can extend perpendicularly from the inwardly facing surface of the guide rails 368, 370. The guide rail 368, 370 and/or the flange 372, 374 can be mechanically coupled to a rotation mechanism 376 disposed on each side of the central section 322 along the stepped structure 344, 346.

The transport system can be moved between a retracted position (FIG. 21) and a deployed position (FIG. 22). In the retracted position, the guide rails 368, 370 are moved into a substantially perpendicular position relative to the top surface 312 such that the rollers 364, 366 and the guide rails 368, 370 are disposed in the respective grooves 348, 350. In the retracted position, the rollers 364, 366 cannot make contact with other structures and cannot be used to transport the robot 300.

In the deployed or extended position, the rotation mechanism 376 is used to rotate the guide rails 368, 370 about 90 degrees towards each other (and towards the central section 322) such that the guide rails 368, 370 extend substantially parallel to the top surface 312. In some embodiments, the rotation mechanism 376 can be, e.g., a linear actuator, or the like, used to position the guide rails 368, 370 in the deployed and retracted positions. The rotation mechanism 376 can drive the rotation of the guide rails 368, 370 using, e.g., gears, sprockets, directly from an inline motor via a cable-pulling mechanism, combinations thereof, or the like. The support flanges 372, 374 can abut the vertical portions of the stepped structure 344, 346 to maintain the position of the guide rails 368, 370. In the deployed position, the guide rails 368, 370 are disposed over the rotating components 352, 354, and the rollers 364, 366 are the uppermost component of the robot 300. The rotating components 352, 354 can engage with the rollers 364, 366 to facilitate rotation of the rollers 364, 366. Thus, if the robot 300 is inverted onto the rollers 364, 366, the rollers 364, 366 can be actuated to move the robot 300 along a surface. In some embodiments, an internal power source (e.g., a battery) can be used to power either the rollers 364, 366 or the rotating components 352, 354, depending on the deployed or retracted position of the guide rails 368, 370.

FIGS. 24-27 show perspective and cross-sectional views of an attachment assembly 378 of the robot 300 and a complementary attachment assembly 380 of an adjacent robot 300. The attachment assemblies 378, 380 are configured to be disposed within the base 302 of respective robots 300. The attachment assembly 378 engages with the attachment assembly 380 to releasably engage and interlock adjacently disposed robots 300 of the same or different configurations, e.g., hexagonal, circular, combinations thereof, or the like. Thus, a combination of robot 300 configurations can be used to interlock and create the desired supporting structure.

The attachment assembly 378 includes a housing formed by top and bottom sections 382, 384. In some embodiments, the top and bottom sections 382, 384 can be in the form of circular interface rings defining a hollow interior 386, 388. The top section 382 is not shown in FIG. 24 for clarity. The interior 386, 388 of the assembly 378 includes a central pivot post 390 around which a rotatable ring 392 is positioned. An engagement arm 394 extends perpendicularly from the ring 392. The length of the arm 394 is dimensioned to extend out of the opening 320 in the base 302 and reach/engage with the attachment assembly 380 of the adjacent robot 300. In particular, the ring 392 can be selectively actuated to rotate to either retract or extend the arm 394 out of the opening 320. The attachment assembly 378 can include a circumferential gap or opening 400 between the top and bottom sections 382, 384, allowing the arm 394 to be rotated 360 degrees.

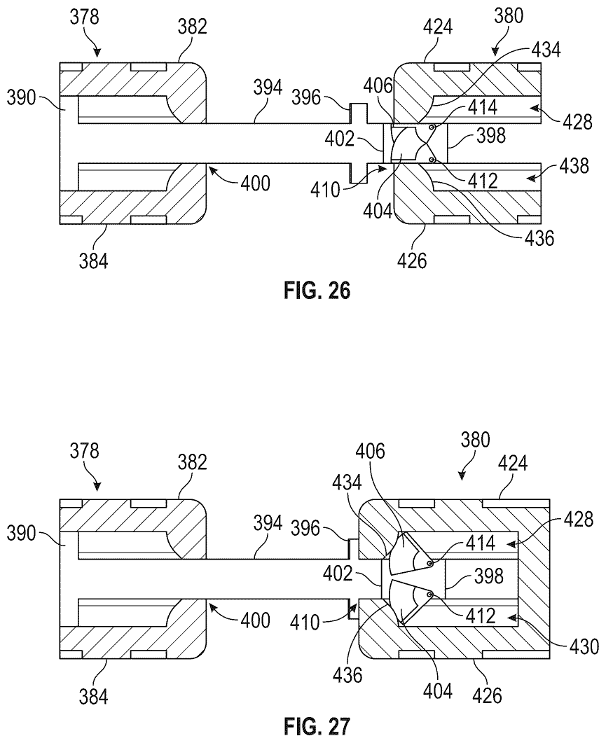

At or near the distal end 398 of the arm 394, a flange 396 can extend substantially perpendicularly from the arm 394. The flange 396 acts as a stop or limit bar for limiting how far the distal end 398 of the arm 394 can extend into the attachment assembly 380 of the adjacent robot 300. The edges 408 of the distal end 398 can be chamfered or curved to assist with insertion of the distal end 398 into the opening 410 of the complementary attachment assembly 380. The distal end 398 includes a slot 402 formed therein, creating a gap between spaced extensions in which engagement features 404, 406 (e.g., wings) can be rotatably positioned. The features 404, 406 are connected within the slot 402 at respective pivot points 412, 414. The features 404, 406 can be spring-loaded and biased to rotate away from each other upwards and downwards relative to the arm 394, as shown in FIG. 25. An angled front face 416, 418 of the features 404, 406 faces towards the distal end 398, such that application of force on the front face 416, 418 forces the feature 404, 406 to rotate inward into the slot 402 (see, e.g., FIG. 26).

The interior 386, 388 of the attachment assembly 378 includes curved inner surfaces 420, 422 that provide an abutting surface for features 404, 406 of other robots 300 (e.g., if an arm 394 of another robot 300 is to be engaged with the attachment assembly 378). However, in FIGS. 24-27, the arm 394 of the attachment assembly 378 is used to engage with the attachment assembly 380. The attachment assembly 380 has a structure substantially similar to the attachment assembly 378. In particular, the attachment assembly 380 also includes top and bottom sections 424, 426 that create a housing with hollow interiors 428, 430. The attachment assembly 378 includes a circumferential or radial opening 410 along the entire perimeter, such that an arm 394 can pass through the opening 410 at any radial position relative to the attachment assembly 380. The attachment assembly 380 includes a central post 432 which can include a similar ring 392 and arm 394, which are not shown for clarity. In some embodiments, each of the attachment assemblies 378, 380 can include one or more rings 392 and arms 394 via, e.g., nesting rotating surface on the central pivot post 390. The interior 428, 430 includes curved inner wall surfaces 434, 436 configured to engage with the features 404, 406.

In operation, the robots 300 are positioned adjacent to each other and the arm 394 of the attachment assembly 378 of the first robot 300 is deployed out of the opening 320 in the base 302 (e.g., FIG. 25). The robots 300 are moved closer to each other such that the distal end 398 of the arm 394 is gradually inserted into the opening 320 of the base 302 of the second robot 300, and through the opening 410 of the attachment assembly 380 of the second robot 300. As the arm 394 is passed through the opening 410, the outer walls of the top and bottom sections 424, 426 impart a force on the features 404, 406, which rotate inwardly within the slot 402 to allow for passage of the features 404, 406 with the distal end 398 through the opening 410 (e.g., FIG. 26). The arm 394 is pushed through the opening 410 until the flange 396 abuts the outer surface of the top and bottom sections 424, 426 (e.g., FIG. 27).

In this position, the features 404, 406 pass beyond the walls of the opening 410, and the spring biases the features 404, 406 outward which engages the features 404, 406 with the inner surfaces 434, 436 (e.g., FIG. 27). Such engagement prevents withdrawal of the arm 394 from the attachment assembly 380, and interlocks the assemblies 378, 380 together. For disengagement, the features 404, 406 can be actuated to rotate inwardly within the slot 402, and the arm 394 can be retracted out of the opening 410 to separate the assemblies 378, 380. In some embodiments, rather than or in addition to being spring-mounted, the features 404, 406 can be mechanically or electrically actuated to rotate inwardly or outwardly (e.g., retract or deploy) to engage or disengage with the assembly 380. In some embodiments, the features 404, 406 can be extended using an actively driven mechanism and/or a passive extending mechanism (e.g., a spring). An actively-driven mechanism, e.g., a rack and pinion mechanism driven by a linear actuator, a cable-driven mechanism, a shape-memory allow actuator, combinations thereof, or the like, can be used to retract the features 404, 406. In some embodiments, a cable extending through the arm 394 can extend from the assembly 378, such that pulling of the cable retracts the features 404, 406.

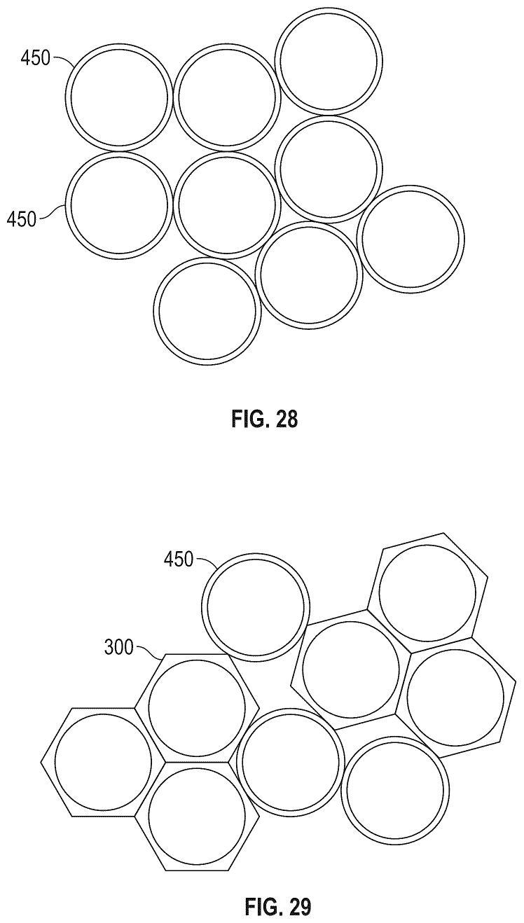

FIG. 28 shows robots 450 having a non-latticed or non-hexagonal configuration interlocked together. The robots 450 can include the attachment assembly 378, 380 discussed herein for releasably interlocking the robots 450. In some embodiments, the robots 450 can be substantially similar to the robots 100, 300, except for the base and bottom component having a round configuration. The robots 450 can thereby be grouped together to form a collective platform capable of supporting greater weight across difficult terrains, for example.

FIG. 29 shows robots 300, 450 interlocked together using attachment assemblies, such as assemblies 378, 380. The attachment assemblies allow for robots 300, 450 of different configurations to be engaged relative to each other, thereby providing variability and collective engagement depending on the needs in the environment. For example, in the interlocked configuration of FIG. 28, larger gaps may exist between the adjacent robots 450 due to their configuration. In contrast, by grouping hexagonal robots 300 together, or even a combination of hexagonal robots 300 and round robots 450, smaller gaps can exist between the robots 300, 450, providing a more uniform platform.

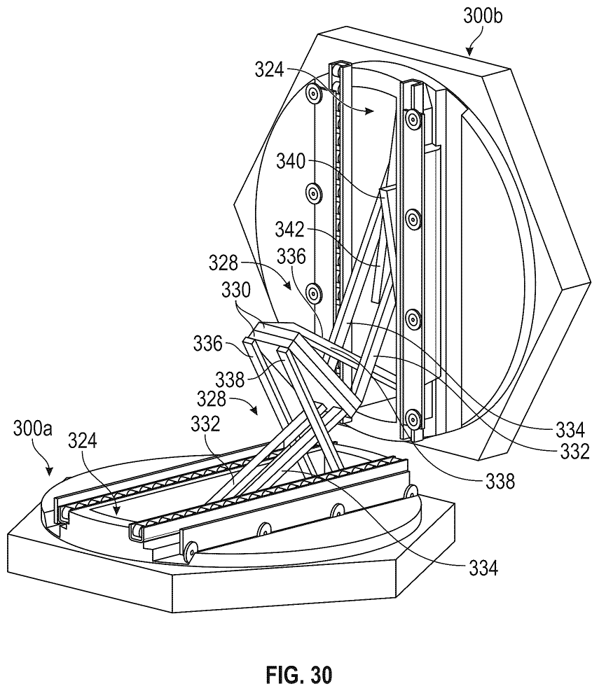

FIG. 30 is a perspective view of robots 300a, 300b in an interlocked and flipping action, and FIGS. 31-33 are cross-sectional views of the platform assembly 328 in a retracted position, a partially extended/lifting position, and a rotated position, respectively. The flipping action illustrated in FIG. 30 can be helpful in either transporting and positioning a robot 300b adjacent to a previously deployed robot 300a, or removing the robot 300b from its previous position adjacent to the robot 300a.

For deployment of the robot 300b, the robot 300b can travel in an inverted or upside down position such that the platform assembly 328 of the robot 300b faces downwardly towards the platform assembly 328 of the robot 300a. The robot 300b aligns itself over the robot 300a and the platforms 330 engage with each other. In some embodiments, engagement between the platforms 330 can be achieved by one or more attachment mechanism types, e.g., electromagnets, complementary pins that the opposing robot clamps onto, melting-based mechanisms, hooks, combinations thereof, or the like. In the engaged position, the platforms 330 cannot be separated from each other. The platform assembly 328 of the robot 300a can extend outward and flip towards the right to position the platform 330 in a substantially vertical orientation relative to horizontal. Subsequently (or concurrently), the platform assembly 328 of the robot 300b can extend outward to move the robot 300b further from the robot 300a. The platform assembly 328 of the robot 300b continues to extend and rotate the robot 300b downward until the robot 300b is positioned immediately adjacent to the robot 300a. Once the robot 300b has been lowered onto a supporting surface, e.g., the ground, or the like, the platforms 330 can be disengaged and the respective platform assemblies 328 retracted. The attachment assemblies 378, 380 can be used to interlock the robots 300a, 300b relative to each other in the aligned position.

For removal of the robot 300b from its position, the opposite action can be taken. In particular, the attachment assemblies 378, 380 can be disengaged, and the platform assemblies 328 of the robots 300a, 300b can be extended such that the platforms 330 are in a vertical orientation. Next, the platforms 330 can be engaged relative to each other. The platform assembly 328 of the robot 300b begins to retract, thereby lifting the robot 300b towards the robot 300a. Subsequently (or concurrently), the platform assembly 328 of the robot 300a beings to retract until the robot 300b is positioned directly over and resting on the robot 300a in an inverted or upside down position. The platforms 330 can be disengaged, allowing the robot 300b to be transported over and away from the robot 300a. Multiple robots 300a, 300b can therefore be used in this manner to create an interlocked platform.

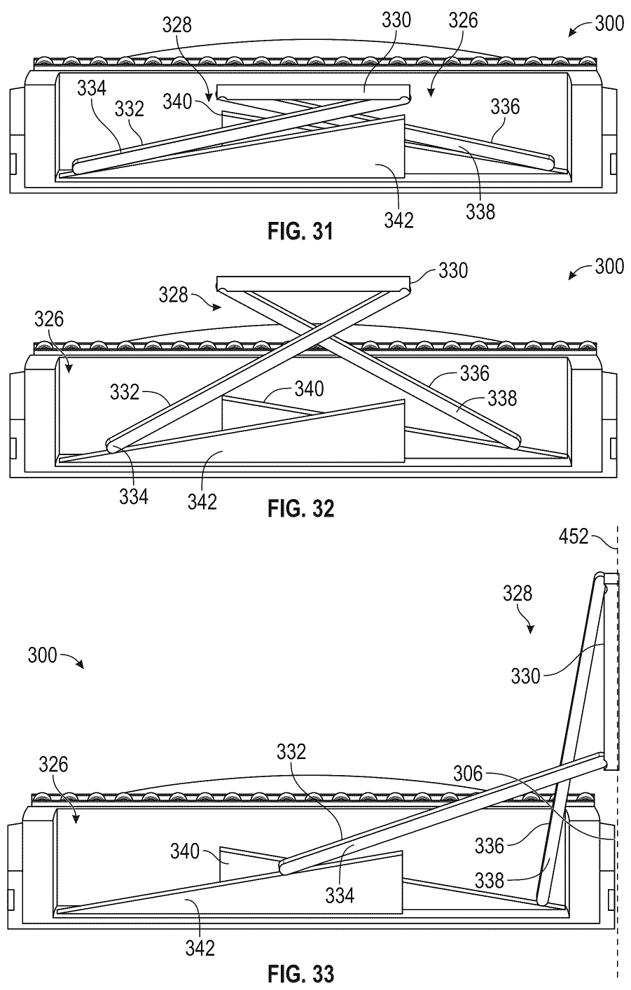

FIGS. 31-33 illustrate the movement of the platform assemblies 328 which can be used to move, lift or flip items positioned on the robot 300, or to engage and flip another robot 300 (as shown in FIG. 30). FIG. 31 shows the platform assembly 328 in a retracted position, such that the top surface of the platform 330 is disposed below the transport assembly. The arms 332-338 can be selectively actuated to slide or move along the ramped structures 340, 342 disposed within the interior 326, thereby lifting or elevating the platform 330 above the plane defined by the transport assembly (see FIG. 32).

The amount of sliding or movement of the respective arms 332-338 can be controlled to achieve the desired angle of the platform 330. The arms 332-338 can be moved to an extreme or maximum position in which the platform 330 is oriented vertically relative to a vertical plane 452 (see FIG. 33). In the vertical orientation, the bottom surface of the platform 330 aligns with and is parallel to the side surface 306 of the base 302. The orientation shown in FIG. 33 provides the ability of the platforms 330 of adjacently positioned robots 300 to engage (as discussed with respect to FIG. 30).

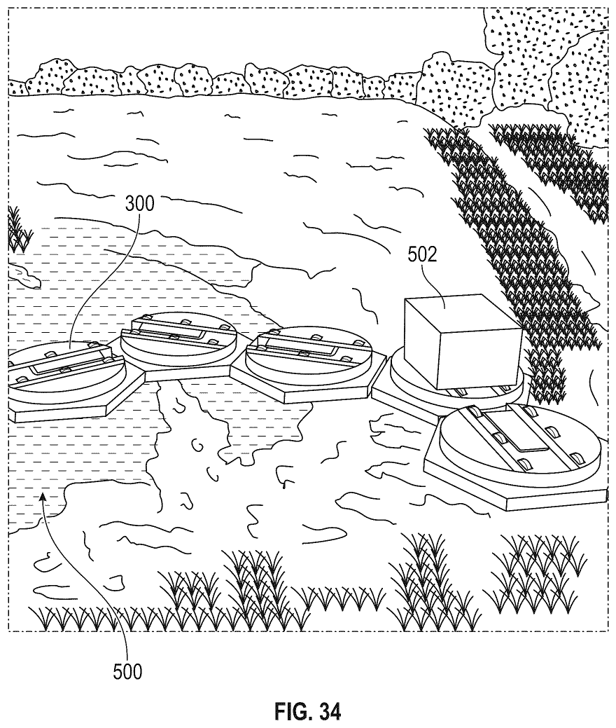

FIG. 34 shows the exemplary robots 300 interlocked to form a floating platform across muddy water 500. The robots 300 can be sequentially positioned starting on dry land and extending into and across the muddy water 500. At each stage, a new robot 300 can be positioned adjacent to the previous robot 300, and the robots 300 are interlocked before the next robot 300 is positioned in the chain. This forms an interlocked group of robots 300 that define a stable platform capable of moving objects 502, or even allowing humans to walk across the water 500. The robots 300 therefore advantageously provide a structure which can be formed in difficult terrain or conditions to assist with necessary operations in such environments.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made explicit herein, without departing from the spirit and scope of the invention.

1. A robot, comprising:
a base;
a top component coupled to the base;
a transportation assembly associated with the top component, wherein the transportation assembly allows for selective movement of the robot relative to any underlying object or surface; and
a pivoting assembly associated with the top component.

2. The robot of claim 1, wherein the base includes openings formed around its perimeter.

3. The robot of claim 2, comprising an attachment assembly configured to extend an arm through one of the openings in the base to releasably interlock with an adjacently disposed secondary robot.

4. The robot of claim 1, comprising a bottom component capable of being releasably secured to a bottom surface of the base.

5. The robot of claim 4, wherein the bottom component includes at least one of a floatation capability for flotation of the robot, or a corrosion/damage resistance.

6. The robot of claim 1, wherein the top component is rotatably coupled to the base.

7. The robot of claim 1, wherein the transportation assembly includes sets of rotating components rotatably coupled to the top component.

8. The robot of claim 1, wherein the transportation assembly includes a pair of rotatable guide rails capable of being positioned in a retracted position and a deployed position, and wherein in the deployed position rollers rotatably coupled to the rotatable guide rails extend above a top surface of the top component.

9. The robot of claim 1, wherein the pivoting assembly includes arms rotatably coupled to a bottom surface of a platform capable of being positioned in a retracted position below a plane defined by the top component and an extended position above the plane defined by the top component.

10. The robot of claim 9, wherein the top component includes a central section with a hollow interior in which the arms are configured to slide or move across ramped structures to move the platform in and out of the hollow interior.

11. The robot of claim 9, wherein the arms are extendable into a maximum position to rotate and orient the platform vertically in a perpendicular position relative to the top component.

12. An interlocking robot assembly system, comprising:
a first robot and a second robot, each of the first and second robots including (i) a base, (ii) a top component coupled to the base, (iii) a transportation assembly associated with the top component, wherein the transportation assembly allows for selective movement of the respective robot relative to any underlying object or surface, (iv) a pivoting assembly associated with the top component, and (v) an engagement assembly; and
wherein the engagement assembly of the first and second robots is configured to releasably interlock the first robot to the second robot.

13. The interlocking robot assembly system of claim 12, wherein the engagement assembly includes openings formed in the base.

14. The interlocking robot assembly system of claim 13, wherein an arm of an attachment assembly of the first robot is configured to extend into one of the openings formed in the base of the second robot to releasably interlock with a complementary attachment assembly of the second robot.

15. The interlocking robot assembly system of claim 12, wherein each of the first and second robots includes a communication interface that allows for transfer of data and power upon releasable interlocking of the first robot to the second robot.

16. The interlocking robot assembly system of claim 12, wherein the pivoting assembly includes arms configured to move or slide along ramped structures to move a platform coupled to the arms between a retracted position and an extended position.

17. The interlocking robot assembly system of claim 16, wherein the first robot is configured to be positioned in an upside-down orientation relative to the second robot, and wherein the platforms of the first and second robots are configured to coupled relative to each other.

18. The interlocking robot assembly system of claim 17, wherein in the coupled position, the arms are configured to be pivoted to flip the first robot about 180° into a right-side-up position adjacent to the second robot.

19. The interlocking robot assembly system of claim 12, wherein the first robot is configured to be positioned in an upside-down orientation relative to the second robot, and the transportation assembly allows for movement of the first robot along the second robot.

20. A method for interlocking robots, comprising:
positioning a first robot adjacent to a second robot, each of the first and second robots including (i) a base, (ii) a top component coupled to the base, (iii) a transportation assembly associated with the top component, wherein the transportation assembly allows for selective movement of the respective robot relative to any underlying object or surface, (iv) a pivoting assembly associated with the top component, and (v) an engagement assembly; and
releasably interlocking the first robot to the second robot with the engagement assembly.
